(19) United States
(12) Patent Application Publication
(10) Pub. No.: US 2007/0285013 A1
(43) Pub. Date: Dec. 13, 2007

(54) Plasma Display Panel and Driving Method Thereof

(76) Inventor: Yoshifumi Amano, Kanagawa (JP)

Correspondence Address: William S. Frommer;Frommer Lawrence & Haug, 745 Fifth Avenue, New York, NY, 10151, US

(21) Appl. No.: 11/578,493

(22) PCT Filed: Sep. 22, 2004
(86) PCT No.: PCT/JP04/14283

§ 371 Date: Jul. 3, 2007

(30) Foreign Application Priority Data
Apr. 13, 2004 (JP) 2004-1118085

(51) Int. Cl. H01J 17/49; G09G 3/288; H01J 11/02

(52) U.S. Cl. 313/584

(57) ABSTRACT

The present invention is to provide an AC type PDP which can be manufactured by an inexpensive thick-film process without a thin-film process which is difficult to manufacture an MgO protection layer and the like and which has a panel structure that can be driven at a low voltage. Of a pair of discharge electrodes, one electrode is formed as a so-called AC type electrode in which a conducting electrode material is formed as an independent floating electrode separated at every pixel, this floating electrode being connected through a dielectric layer to a bus electrode in a capacity coupling fashion. The other discharge electrode is formed as a so-called DC type electrode in which a bus electrode is exposed to the discharge space as it is. The above-mentioned two electrodes are paired to form an AC type PDP which carries out discharge display

### TECHNICAL FIELD

This invention relates to a plasma display panel and a driving method thereof.

### BACKGROUND ART

The mainstream of a PDP (plasma display panel), which is now put to practical use, is a so-called three-electrode surface-discharging type PDP (see FIG. 2) including a pair of transparent discharge electrodes, that is, so-called sustain electrodes provided on the front surface side, a transparent low-melting point glass layers covering the surface of the discharge electrodes, an MgO layer, that is, a magnesium oxide layer covering the surface of the low-melting point glass layer as a protection layer, so-called address electrodes disposed on the back surface side and which cross the above-described sustain electrodes to construct an XY matrix, a partition regulating pixels and a fluorescent material coated on the surface. This PDP is an AC type PDP in which the surface of the discharge electrode is covered with the dielectric layer and the MgO protection layer and it is characterized by a so-called reflection type fluorescent screen in which the fluorescent screen is provided at the back surface side.

On the other hand, a so-called DC type PDP is known, in which an electrode surface is not coated with a dielectric layer. For example, the existing technology proposed by the same assignee of the present invention relates to an AC/DC hybrid type PDP (see Cited Patent Reference 1) having a structure in which its fundamental structure is the same as that of the above-described DC type PDP, a trigger discharge electrode is disposed on the lower layer, the trigger discharge electrode is coated with a dielectric layer, a DC type PDP structure being formed on the upper surface of the dielectric layer as shown in FIG. 13.

Also, there is known a so-called semi-AC type PDP structure in which one of metal discharge electrodes is exposed to the discharge space as it is, the other of the metal discharge electrodes being coated with a dielectric material as shown in FIG. 14. The prior-art (see Cited Patent Reference 2) proposed by the same assignee of the present invention has disclosed this PDP structure and a driving method thereof.

Also, there is known a structure (FIG. 15) having the standard three-electrode surface-discharging type PDP including the above-described reflection fluorescent screen and in which transparent electrode (discharge auxiliary electrode) similar to the discharge electrode, which is not covered with a dielectric layer, is formed as a floating electrode separated at every pixel on the surface of the discharge electrode dielectric layer constructed by the transparent electrode on the front surface side and the protection layer (see Cited Patent Reference 3).

Also, in the patent application (International Application PCT/JP03/11777) previously proposed by the same assignee of the present invention, there was proposed a structure shown in FIG. 16 in which a discharge electrode is formed on the back surface side in order to remove the transparent electrode and the MgO protection layer, a cathode material with conductivity and which has high secondary electron emissivity, such as LaB₆ being formed as a floating electrode on the bus electrode at every pixel through a dielectric layer.

Also, there is a report (see Cited Non-Patent Reference 1) in which the above-described LaB₆ is used as a cathode of the DC type PDP.

[Cited Patent Reference 1]: Japanese Published Patent Application No. 58-30038

[Cited Patent Reference 2]: International Application PCT/JP97/03299

[Cited Patent Reference 3]: Japanese Published Patent Application No. 11-273573

[Cited Non-Patent Reference 1]: “Screened LaB6 for DCPDP”, International Display Research Conference, 1998

### DISCLOSURE OF THE INVENTION

However, the above-mentioned preceding inventions and technologies encounter with many problems that should be solved.

First, in the so-called three-electrode surface-discharging type PDP (FIG. 12) which is now generally available and which includes the above-described reflection type fluorescent screen, it is requested that the discharge electrode, the dielectric layer, the MgO protection layer and the like on the front surface side should be made transparent as much as possible so as not to disturb light emitted from the fluorescent screen so that many thin film processes become necessary. Accordingly, there are serious problems from a manufacturing process standpoint.

Also, since the MgO protection layer is formed by a vacuum evaporation coating method, a system for such vacuum evaporation coating is unavoidably large-scale and expensive. The semi-AC type PDP structure (FIG. 14) described on the above Cited Patent Reference 2 has to form the MgO protection layer and therefore encounters with similar problems.

On the other hand, although it can be expected that the PDP (FIG. 15) having the structure described on the above-described Cited Patent Reference 3 is able to improve light-emission efficiency, since its fundamental structure is of the three-electrode surface-discharging type PDP which has the general reflection type fluorescent screen, the floating electrode should be made transparent, and at present, it should be made of ITO, that is, indium tin oxide or Nesa glass, that is, tin oxide and the like. These materials are, however, large in electric resistance and they are poor in secondary electron emissivity. Further, these materials are weak in ion-bombardment and hence they are not suitable for practical use.

Also, in the PDP having the structure, shown in FIG. 16, of the previously-proposed invention, since the discharge electrode is disposed on the back surface side, the material of the electrode is not limited to the transparent electrode. There is an advantage in which an optimum material, for example, LaB₆, that is, lanthanum hexaboride and the like can be used as the material of the above electrode in consideration of efficiency necessary for the discharge electrode, that is, electric conductivity, secondary electron emissivity, anti-ion bombardment property and the like. However, although the MgO protection layer can be made unnecessary, it is hard to say that this structure may sufficiently utilize the essence of the characteristics of the AC type PDO having the conducting electrode in the discharge space.

Also, since the PDP described on the above Cited Non-Patent Reference 1 is the DC type PDP, it is inferior to the AC type PDP in efficiency such as life and luminance.

In view of the aforesaid aspects, the present invention intends to provide a plasma display panel which can be manufactured by an inexpensive thick-film process without a thin-film process which is difficult to manufacture an MgO protection layer. Also, the present invention intends to provide a plasma display panel having a panel structure that can be driven at a low voltage.

In order to solve the above-described problems, as the first invention according to claim 1, as shown in FIG. 1, a three-electrode type PDP includes a plurality of stripe-like electrodes, that is, so-called address electrodes 7 extended in the longitudinal direction and opposing bus electrodes 3 and 4 constructing a pair of a plurality of main discharge electrodes, that is, sustain electrodes separated by partitions 6 so that they are extended with a proper interval in the lateral direction, one side of the pair of the bus electrodes, that is, the bus electrode 3 is covered with a dielectric layer 2 and a discharge electrode 5, which is an AC type electrode having a so-called conducting electrode in which a material suitable as the material of the discharge electrode, for example, LaB₆ having high secondary electron emissivity, that is, lanthanum hexaboride, CNT, that is, carbon nano tube, or RuO₂, that is, ruthenium oxide with excellent anti-ion bombardment property is separated at every pixel to form an independent island-like electrode. The other bus electrode 4 is not covered with the dielectric layer 2 and the bus electrode is left as it is. Alternatively, the above-described discharge electrode material is directly coated on this bus electrode to form a so-called DC electrode and these bus electrodes are paired to form the discharge electrodes.

Also, as the second invention according to claim 2, as shown in FIG. 5, the above similar floating electrodes 5 are formed on the upper surface of the above-described bus electrode 3 through the above-described dielectric layer 2 in such a manner that they are separated in the longitudinal direction which is the direction of the address electrode 7, in other words, at both ends of the line width direction of the bus electrode 3.

Also, as the third invention according to claim 3, as shown in FIG. 8, this plasma display panel has the electrode arrangement in which the other DC type electrodes opposing the AC type discharge electrodes are provided at both sides of the AC type electrode.

In FIG. 8, the DC type discharge electrodes 4 and 9 are shared by adjacent pixels in order to carry out operations shown in FIG. 10.

A method of driving the PDP having the electrode arrangement according to claim 3 comprising the steps of, as shown in FIG. 11, maintaining electric potential of one DC type discharge electrode 4 to be higher than electric potential of the AC type electrode 5 of DC type electrodes at both sides of the above-described AC type electrode 5 during the sustain period, maintaining electric potential of the other DC type electrode 4 to be lower than electric potential of the AC type electrode 5, generating sustain discharge 1 from the DC type electrode 4 of the high electric potential side to the AC type electrode 5 by alternately applying positive and negative voltages to the AC type electrode 5 as shown in FIG. 10 and generating sustain discharge 2 from the AC type electrode 5 to the DC electrode 9. As described above, this method is a driving method which shifts discharges in response to each polarity of sustain discharge.

Although the first invention according to claim 1 and the second invention according to claim 2 include the floating discharge electrodes 5 separated at every pixel through the dielectric layer in the bus electrode extended in a stripe-like fashion similarly to the arrangement of the previously-proposed invention shown in FIG. 16, they are different from the previously-proposed invention in a so-called DC type electrode of a stripe-shape in which, as shown in FIG. 1, the other electrode 4 opposing the above-described floating discharge electrode 5 is not separated at every pixel, the bus electrode 4 is not separated through the dielectric layer 2 or a conducting electrode material is coated on the bus electrode 4.

According to the inventive arrangement common to the present application, that is, one electrode is formed as an AC type electrode having electrostatic capacity through the dielectric layer and the other electrode is formed as a conducting stripe electrode, that is, a DC type electrode in which a current supplying electrode serving as the bus electrode is exposed to the discharge space similarly to the electrode of the DC type PDP. Accordingly, there can be achieved large effects unlike the prior art.

Effects of the present invention will be enumerated as follows.

First, the first effect will be described. Since the conducting stripe electrode side, that is, the electrode 4 has no electrostatic capacity, that is, load to cause a voltage drop unlike the structure, shown in FIG. 16, of the prior art in which both of the pair of the discharge electrodes have electrostatic capacity, it is possible to lower a drive voltage.

That is, also in the related-art general three-electrode surface-discharging type PDP shown in FIG. 12 or also in the structure shown in FIG. 16, two electrostatic capacities formed on the electrodes are inserted into the discharge path in series so that a voltage applied to the discharge space is lowered by a voltage drop at this portion, that is, a drive voltage should be increased. According to the structure of the present invention in which only one side has an electrostatic capacity, since there is one electrostatic capacity, accordingly, electric potential can be prevented from being lowered much and hence it is possible to increase the voltage applied to the discharge space.

The second effect will be described. Since one side of the discharge electrode has no capacity load caused by the dielectric layer and a voltage drop is not caused by a discharging current, the opposing electrode can be made common to a plurality of the other electrodes 5 with the capacitive load.

The reason for this will be described. That is, since one discharge electrode has no capacitive load and it is low in impedance, a large discharging current of a plurality of electrodes can flow through this discharge electrode.

As a result, pixels can be formed at high density and it becomes possible to make the plasma display panel become high in resolution.

The third effect will be described. The plasma display panel can be manufactured with ease and it becomes possible to simplify the manufacturing process.

In the structure, shown in FIG. 16, of the previously-proposed invention, since fluctuations of the shape of the floating electrode lead to fluctuations of the electrostatic capacity, when the floating electrode is formed on both of the pair of the discharge electrodes, the fluctuations of the two electrostatic capacities are superimposed upon the above fluctuations to considerably affect operation conditions.

On the other hand, if the floating electrode for regulating the electrostatic capacity is formed on one side of the discharge electrodes as in the present invention, then the other electrode is low in impedance and it has no connection with fluctuations of shape and line width. Therefore, it is possible to maintain a wide operation range without causing difficulties from a manufacturing standpoint.

The fourth effect will be described. In particular, in the structure, shown in FIG. 5, of claim 2, two independent electrodes 5 can be located relative to one bus electrode 3 and hence resolution can be improved.

The fifth and sixth effects will be described. In particular, in the structure, shown in FIG. 8, of claim 3, as is described with reference to FIG. 11 which show timings of pulses to drive the above structure, during a so-called sustain operation period in which address discharge is generated by sequentially applying a scanning pulse to the electrode 3 serving as the AC type electrode having the electrostatic capacity in synchronism with a signal pulse of the electrode 7 and in which discharge is continuously maintained by superimposing resultant wall electric charges upon an applied alternating current pulse, electric potential of one of the DC type electrodes of opposing two sides is held high and electric potential of the other one is held low, whereby a voltage of an AC pulse can be lowered by an amount of DC electric potential.

Also, the seventh effect will be described. As was described as the second effect, since the side of the DC type discharge electrode 4 is low in impedance and it is able to supply a discharge electric current to a plurality of pixels, as shown in FIG. 8, one DC type discharge electrode 4 can be shared as the opposing electrode of the adjacent AC type electrodes 5 on both sides.

### BRIEF DESCRIPTION OF DRAWINGS

FIG. 1 is a schematic arrangement diagram (expanded perspective view) of a PDP of an inventive example 1 according to the present invention;

FIG. 2 is a plan view to which reference will be made in explaining electrode arrangements of the PDP of the inventive example 1;

FIG. 3 is a schematic cross-sectional view to which reference will be made in explaining operations of the PDP of the inventive example 1;

FIG. 4 is a diagram showing operation pulses by which the PDP of the inventive example 1 is driven;

FIG. 5 is a schematic arrangement diagram (expanded perspective view) of a PDP of an inventive example 2 according to the present invention;

FIG. 6 is a plan view showing electrode arrangements of the PDP of the inventive example 2;

FIG. 7 is a schematic cross-sectional view to which reference will be made in explaining operations of the PDP of the inventive example 2;

FIG. 8 is a schematic arrangement diagram (expanded perspective view) of a PDP of an inventive example 3;

FIG. 9 is a plan view to which reference will be made in explaining electrode arrangements of the PDP of the inventive example 3;

FIG. 10 is a schematic cross-sectional view to which reference will be made in explaining operations of the PDP of the inventive example 3;

FIG. 11 is a diagram showing operation pulses by which the PDP of the inventive example 3 is driven;

FIG. 12 is an expanded perspective view of a three-electrode surface-discharging type PDP according to an example of the prior art;

FIG. 13 is an expanded perspective view of an AC/DC hybrid type PDP including a trigger electrode according to an example of the prior art;

FIG. 14 is an expanded perspective view of a semi-AC type PDP according to an example of the prior art;

FIG. 15 is a cross-sectional view of a three-electrode surface-discharging type PDP including a conducting auxiliary discharge electrode according to an example of the prior art; and

FIG. 16 is an expanded perspective of an AC type PDP including a conducting electrode.

### BEST MODE FOR CARRYING OUT THE INVENTION

Of a pair of discharge electrodes, one side of the discharge electrodes is formed as a discharge electrode of a floating pattern in which a bus electrode for supplying a discharging current is covered with a dielectric layer, a conducting electrode material with excellent discharge electrode characteristics, for example, LaB₆ or the like is separated at every pixel across the bus electrode and the dielectric layer. The other side of the discharge electrodes is formed as a stripe-like discharge electrode in which the bus electrode is not covered with the dielectric layer and exposed to the discharge space or the surface of the bus electrode is coated with the above-described similar conducting electrode material but it is not covered with the dielectric layer. An electrostatic capacity for accumulating wall electric charges necessary for memory function is formed on one side of the pair of electrodes.

An address electrode may be formed on any one of the back surface side and the front surface side. Also, a fluorescent material may be formed on a partition on the back surface side close to the above-described discharge electrode or the front surface side substrate.

### INVENTIVE EXAMPLE 1

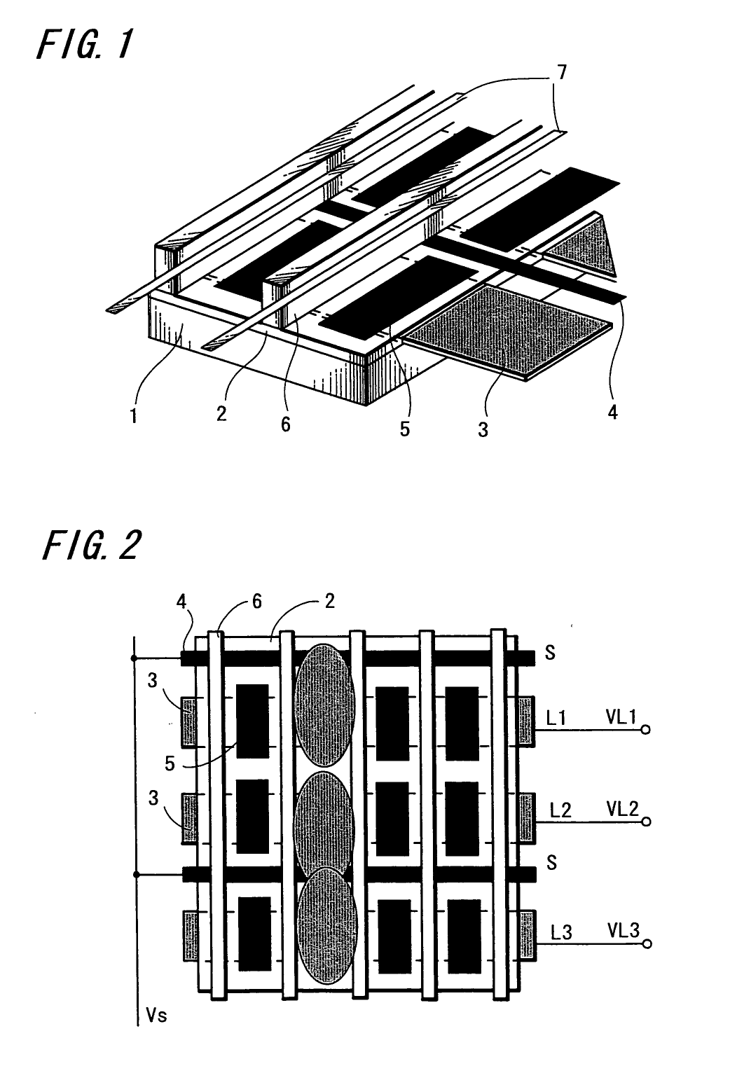

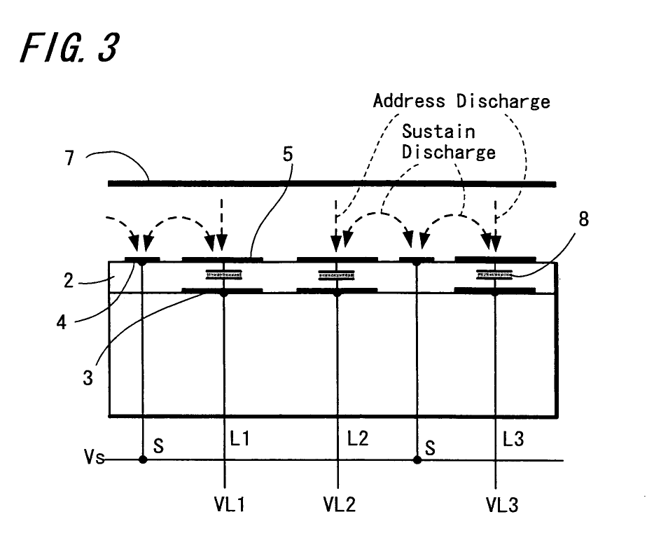

FIG. 1 is a schematic arrangement diagram (expanded perspective view) of a PDP (plasma display panel) of an inventive example 1 according to the present invention and FIG. 2 is a plan view thereof. FIG. 3 is a schematic cross-sectional view showing a simplified arrangement of the PDP in order to explain operations of the PDP of this inventive example 1.

First, a rear surface side glass substrate 1 has formed thereon a bus electrode 3 extending in the lateral direction of the screen and a discharge electrode 4 extended in parallel to the bus electrode.

The bus electrode 3 is covered with a dielectric layer 2 and the discharge electrode 4 is directly exposed in the discharge space.

While the discharge electrode 4 is formed on the dielectric layer 2 in FIG. 1, it is needless to say that the discharge electrode may be directly formed on the glass substrate 1 similarly to the bus electrode 3. In that case, the dielectric layer 2 may cover only the bus electrode 3.

A discharge electrode 5 is formed on the dielectric layer 2. While this discharge electrode 5 is made of a conducting material, since this discharge electrode is shaped like an island separated at every pixel as shown in FIG. 1, an electrostatic capacity 8 that is independent at every pixel is formed between the bus electrode 3 and the dielectric layer 2 as shown in FIG. 3.

Since the bus electrode 3 is not directly exposed to the discharge space, the bus electrode does not need characteristics of the discharge electrode and it can be easily obtained by baking an ink paste having satisfactory electric conductivity, such as gold, silver and nickel, at a temperature ranging of from 500 to 600° C. after the above ink paste was treated by screen-printing.

The dielectric layer 2 that coats the bus electrode 3 can be obtained by baking a low melting-point glass ink paste at a temperature ranging of from 500 to 600° C. after the low-melting point glass ink paste was formed so as to have a thickness ranging of from approximately 20 to 30 μm was formed by a suitable method such as similar screen-printing in the same way as that of the ordinary AC type PDP.

The discharge electrode 5 and the discharge electrode 4 that may serve as main discharge electrodes can be made of a material suitable for discharge, that is, a material with high secondary electron emissivity and excellent anti-ion bombardment property, such as LaB₆ (lanthanum hexaboride), CNT (carbon nano tube) or RuO₂ (ruthenium oxide).

Insofar as the surface, which is exposed to the discharge space, of the discharge electrode 4 is coated with the above-described material, the material with excellent electric conductivity, such as silver and nickel, may be formed on the lower layer of the above discharge electrode by a suitable method such as screen-printing similarly to the bus electrode 3.

The electrode materials of the discharge electrodes 4 and 5 may be formed as paste-like materials by screen-printing, metal plating, electrostatic coating or they can be formed as powder-like materials by several methods such as dusting.

The arrangement of the address electrode 7 is not made clear, in particular, in FIG. 1. The reason for this is that such arrangement of the address electrode is not directly related to the essence of the present invention and therefore need not be described in detail.

The address electrode 7 is formed on the front surface substrate opposing to the back surface substrate 1 or it is formed on the partition 6. Also, unless the address electrode 7 is covered with the dielectric layer, the address electrode can be operated in the same way similarly to other Peps.

Further, in this embodiment, the line width of the bus electrode 3 is wide as compared with that of the discharge electrode 4. The reason for this is that the electrostatic capacity 8 formed between the discharge electrode 5 and the bus electrode 8 should be increased in order to enable a sufficiently large discharging current to be supplied.

On the other hand, since capacitive load is not formed on the side of the discharge electrode 4, a discharging current can flow through the discharge electrode 4 regardless of its line width so long as it has sufficiently large electric conductivity. Then, utilization factor of the area can be improved as the line width of the discharge electrode 4 is decreased and hence resolution of the PDP can be increased.

Also, because of similar reasons, adjacent pixels on both sides of the discharge electrode 4 can be shared as opposing electrodes upon main discharging, which is mentioned specially as principal effect of the present invention, that is, the above-described seventh effect.

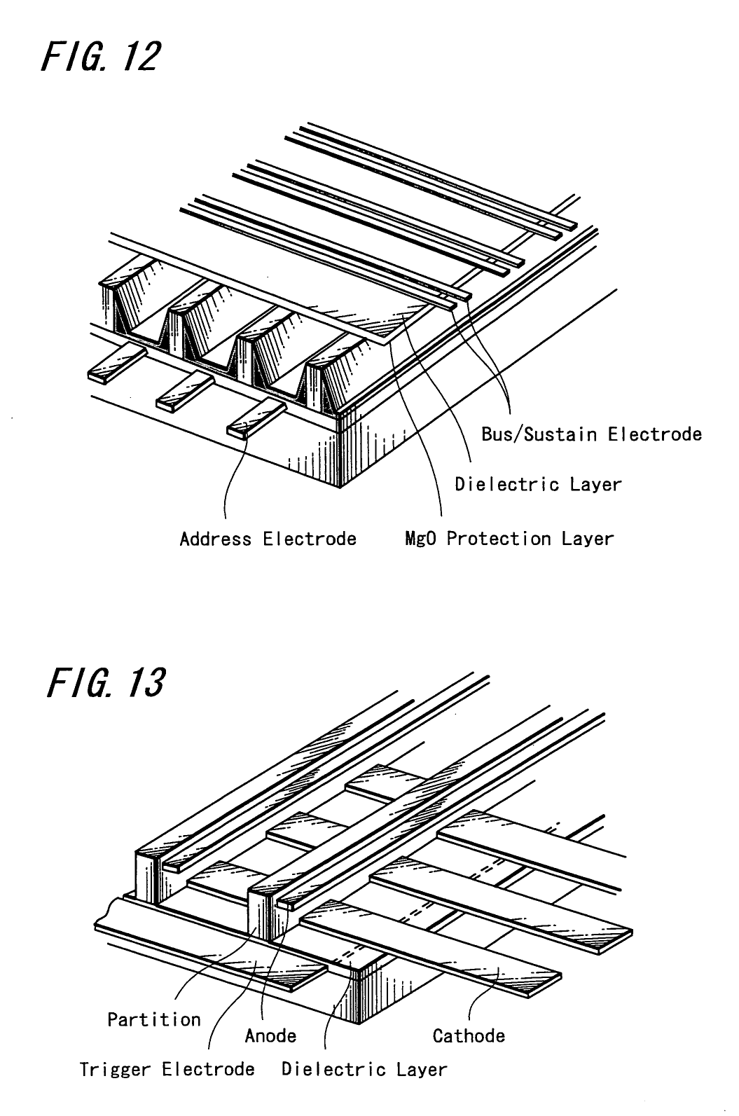

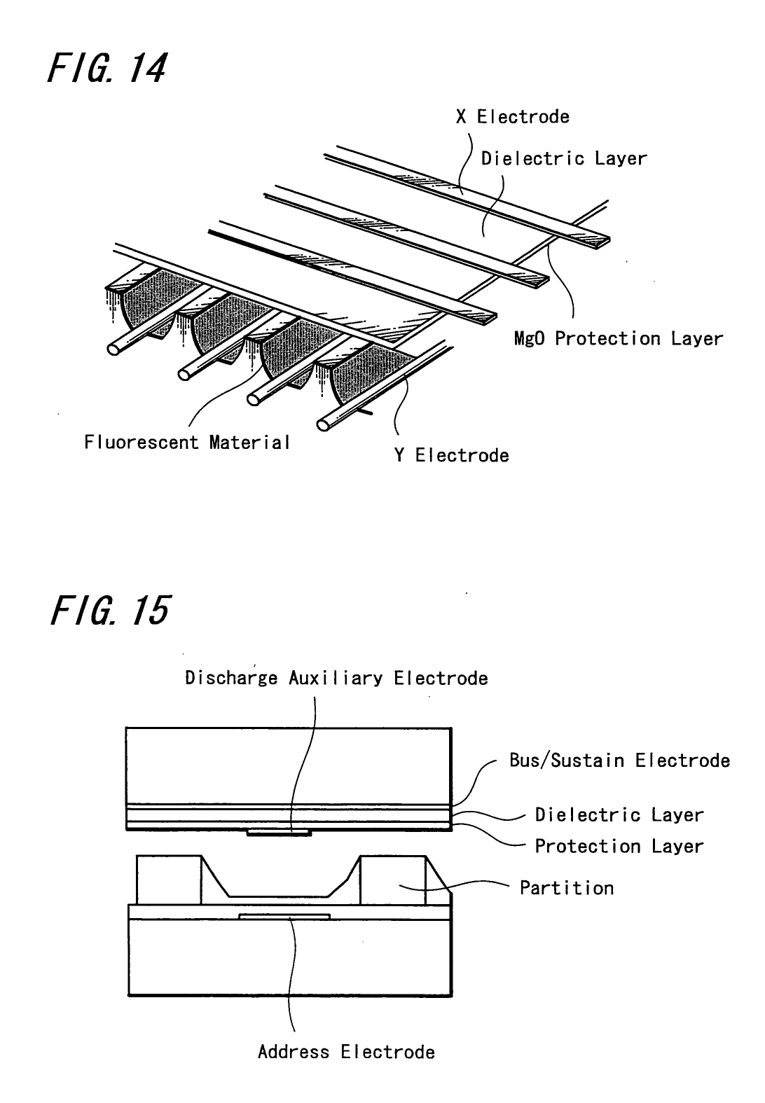

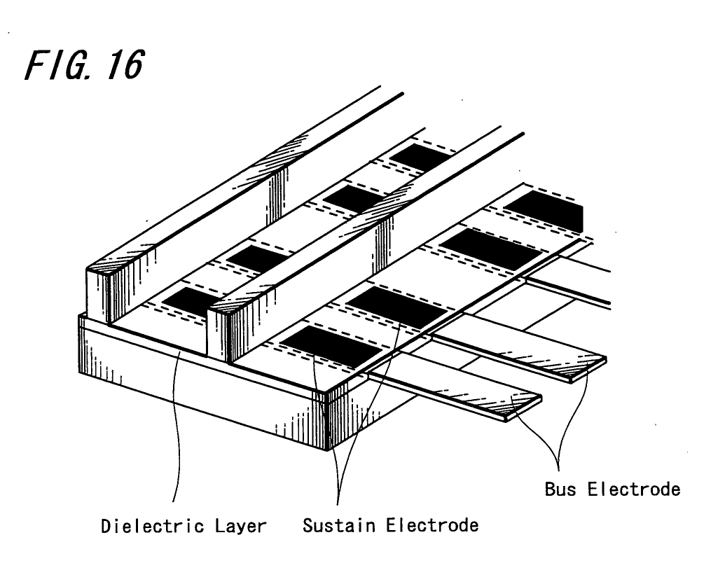

Also, in a color PDP, ultraviolet rays generated from discharging irradiate the fluorescent material to emit light. A portion with which this fluorescent material is coated is not related to the essence of the present invention and it is not shown for simplicity. By way of example, it is needless to say that the wall surface of the partition 6 or the front surface side glass substrate may be coated with the above fluorescent material similarly to the PDP shown in FIG. 12 and other Peps having prior-art structures.

Also, the respective bus electrodes 3 (L1, L2, L3, . . . ) extend in the direction perpendicular to the address electrode 7 (not shown in FIG. 2) extended in the longitudinal direction of the picture screen to construct an XY matrix.

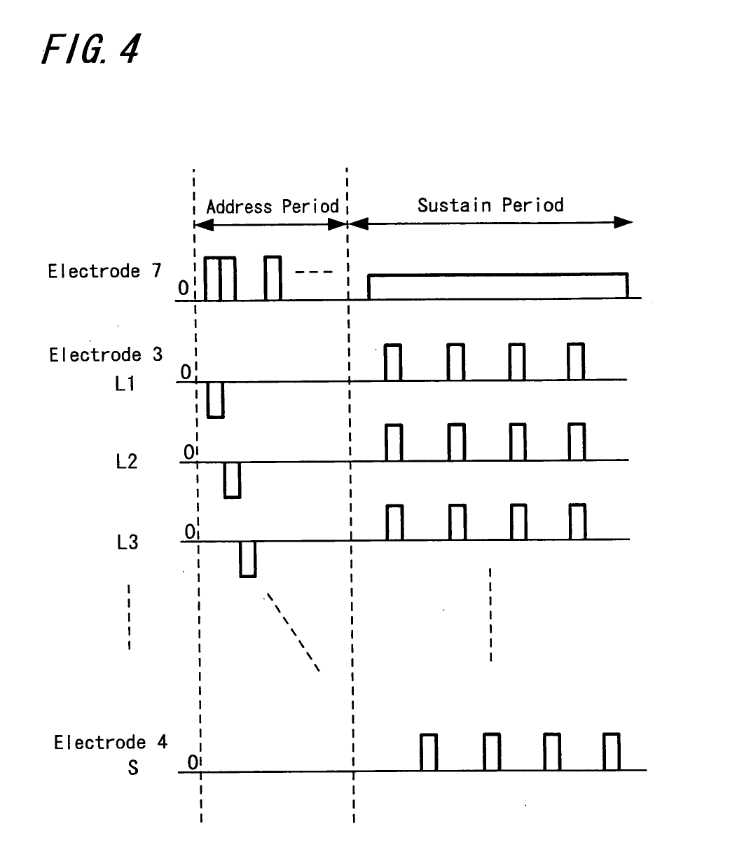

Next, FIG. 4 is a diagram showing examples of timings of operation pulses applied to the PDP having the structure shown in FIGS. 1 and 2.

As shown in FIG. 4, the manner in which the PDP having the structure shown in FIG. 1 is driven is fundamentally the same as that of the so-called three-electrode surface-discharging AC type PDP having the prior-art structure.

During the address period, a signal voltage is applied to the electrode 7 serving as the address electrode to cause address discharging to occur between it and scanning pulses sequentially applied to the bus electrodes 3 (L1, L2, L3, . . . ) with the result that electric charges corresponding to the signal are accumulated in the electrostatic capacity 8 formed between the bus electrode 3 and the floating discharge electrode 5. A wall voltage appears in the floating discharge electrode 5 of the pixel in which the electric charges are formed similarly to the ordinary AC type PDP so that electric potential of the electrode 5 differs at every pixel depending on the presence of address discharging. Then, when the plasma display panel is driven as shown in FIG. 4, positive electric charges are accumulated in the discharge electrode 5 in which address discharging is generated and hence electric potential superimposed upon electric potential of the bus electrode 3 becomes electric potential of the electrode 5.

During the sustain period, similarly to the ordinary AC type PDP, memory operations may be carried out by using the above-described wall electric charge with application of sustain pulses to the electrodes 3 and 4 alternately. In the example shown in FIG. 4, sustain pulses with the same polarity are alternately applied to the electrodes 3 and 4.

### INVENTIVE EXAMPLE 2

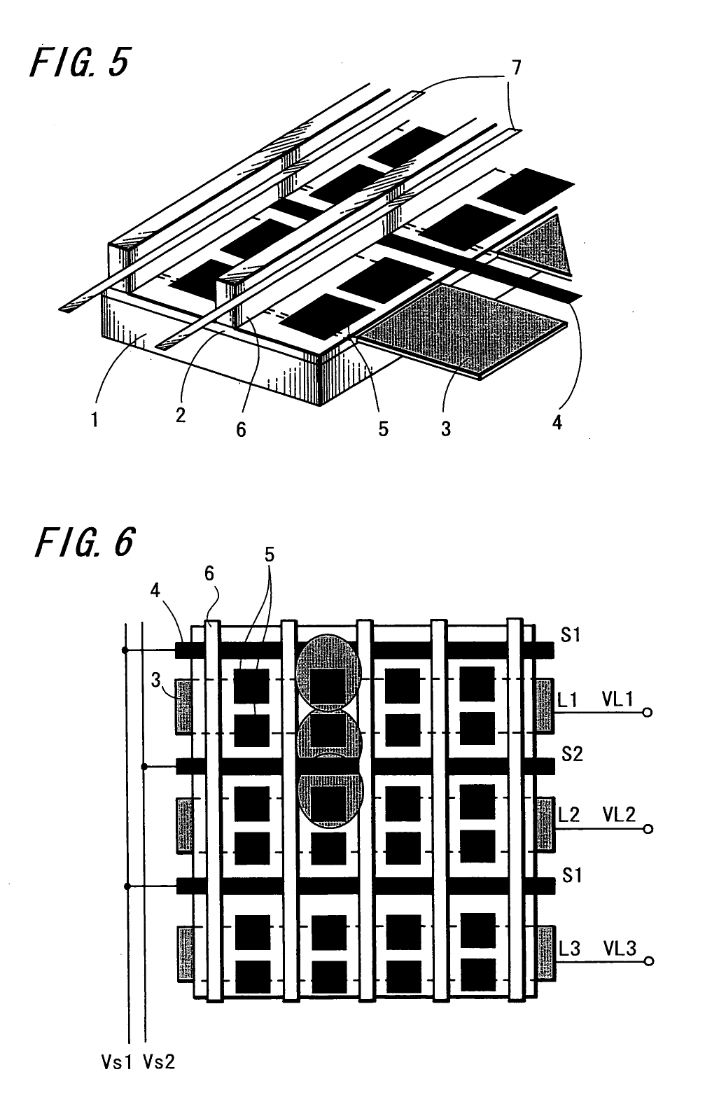

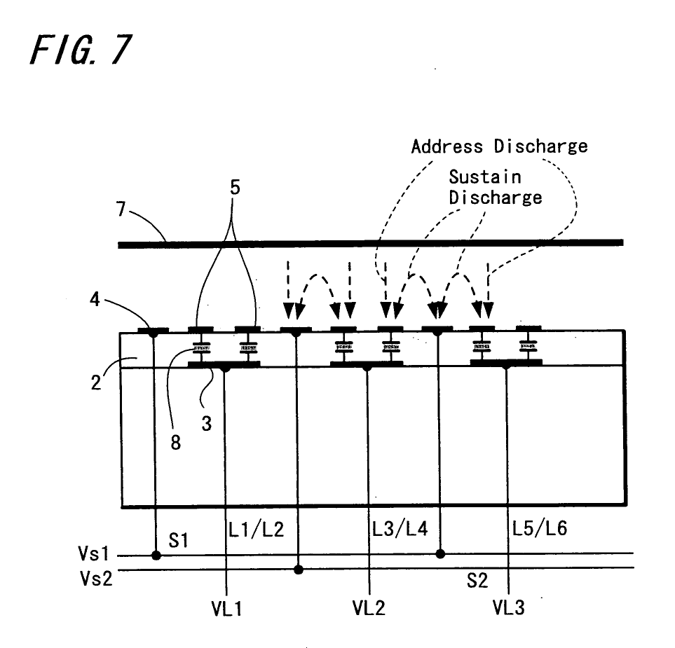

FIG. 5 shows a schematic arrangement diagram (expanded perspective view) of a PDP (plasma display panel) according to the inventive example 2 of the present invention and FIG. 6 is a plan view thereof. In order to explain operations of the PDP according to this inventive example 2, FIG. 7 shows a schematic cross-sectional view of the simplified arrangement of the PDP.

In the PDP of this inventive example, 2, arrangements identical to those of the PDP of the inventive example 1 are denoted by identical reference numerals and therefore need not be described.

In the PDP of the inventive example 2, the two floating discharge electrodes 5 are separately formed at both sides of the longitudinal direction which is the direction of the address electrode 7, that is, the line width direction of the bus electrode 3.

According to the above arrangement, since the two independent discharge electrodes 5 are provided with respect to one bus electrode 3, it is possible to improve resolution.

### INVENTIVE EXAMPLE 3

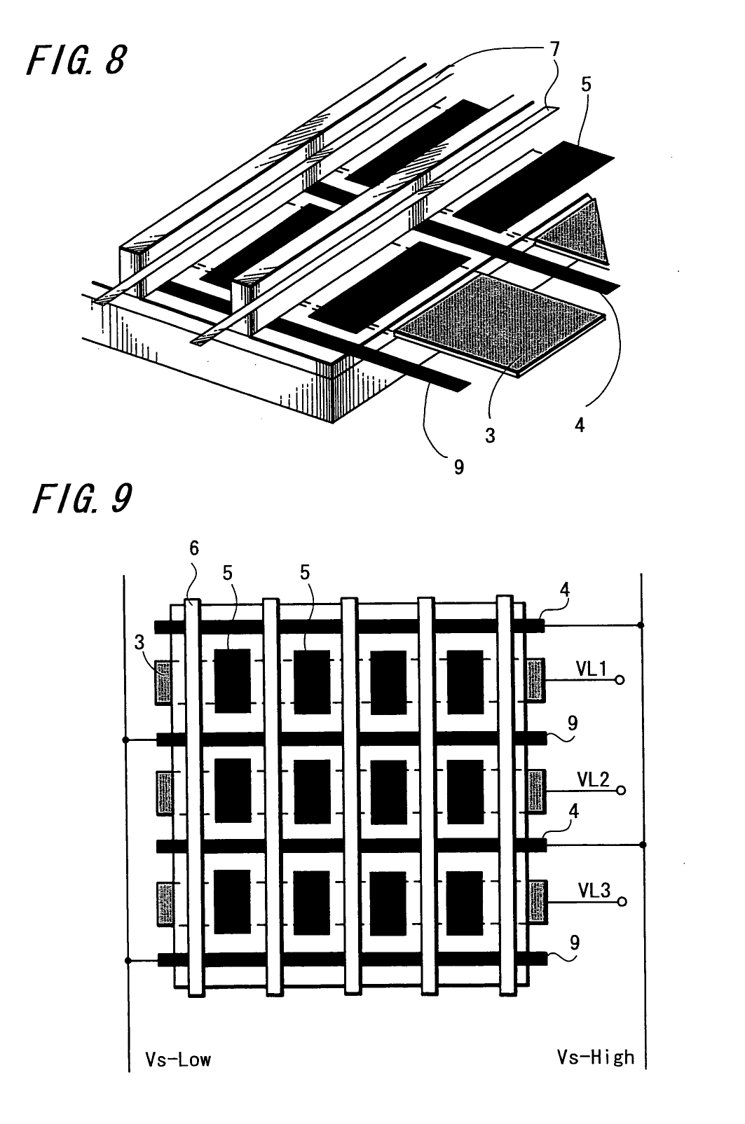

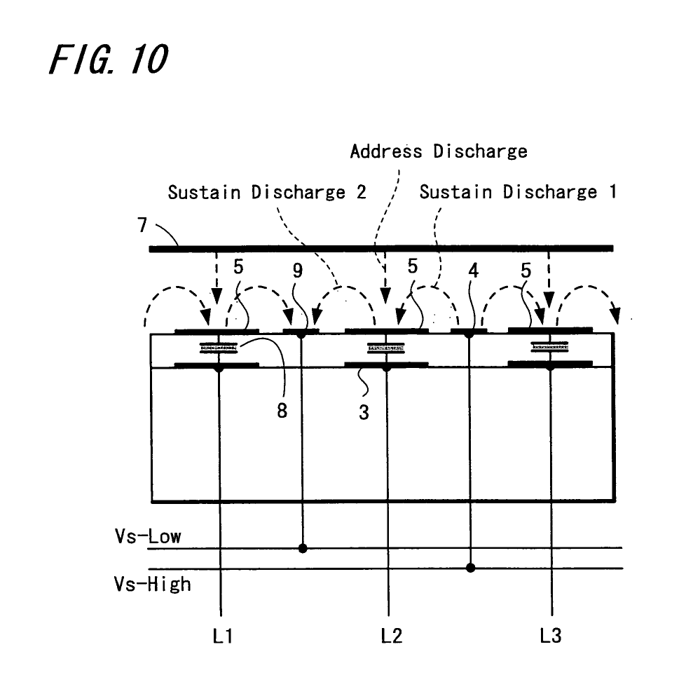

FIG. 8 shows a schematic arrangement diagram (expanded perspective view) of a PDP (plasma display panel) according to an inventive example 3 of the present invention and FIG. 9 shows a plan view thereof. Also, in order to explain operation of the PDP according to this inventive example 3, FIG. 10 shows a schematic cross-sectional view of the simplified arrangement of the PDP.

In the PDP according to this inventive example 3, arrangements identical to those of the PDP of the inventive example 1 are denoted by identical reference numerals and therefore need not be described.

In the PDP according to the inventive example 3, the discharge electrodes 4 and 9 serving as the DC type electrodes and which are opposed to the floating discharge electrode 5 are disposed at both sides of the floating discharge electrode 5. Then, the discharge electrodes 4 and 9 which serve as the DC type electrodes are formed commonly by the pixels adjoining in the longitudinal direction.

According to the above arrangement, one DC type discharge electrodes 4 and 9 can be shared as the opposing electrodes of the floating discharge electrodes of the two pixels adjoining in the longitudinal direction, thereby making it possible to improve resolution.

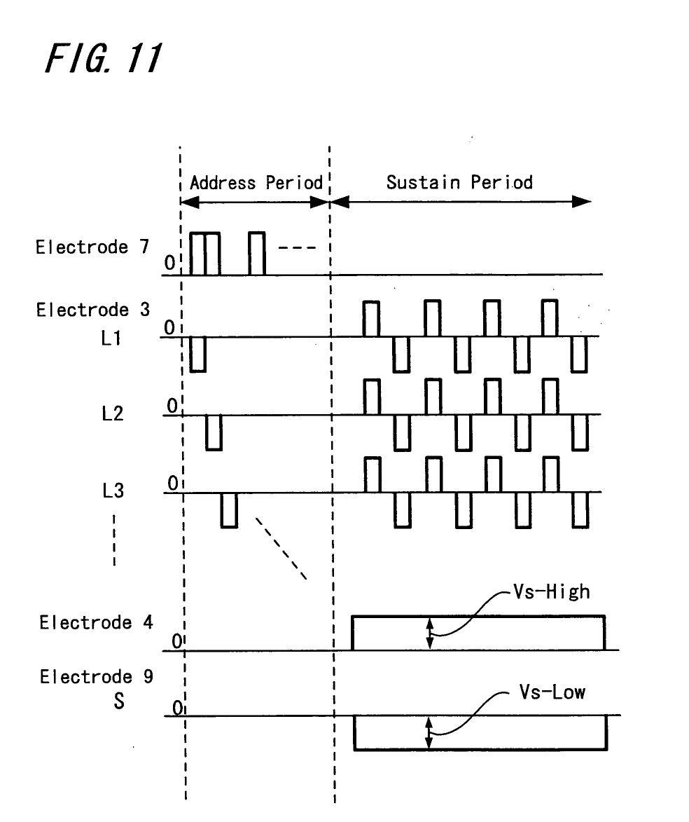

Next, FIG. 11 shows examples of timings of operation pulses applied to drive the PDP having the structure shown in FIGS. 8 and 9.

As shown in FIG. 11, during the address period, a signal voltage is applied to the electrode 7 serving as the address electrode to cause address discharging to occur between it and scanning pulses sequentially applied to the bus electrodes 3 (L1, L2, L3, . . . ) with the result that electric charges corresponding to the signal are accumulated in the electrostatic capacity 8 formed between the bus electrode 3 and the floating discharge electrode 5. Since a wall voltage appears in the floating discharge electrode 5 of the pixel in which the electric charges are formed similarly to the discharge electrode of the ordinary AC type PDP, electric potential of the electrode 5 differs at every pixel depending on the presence of the address discharging. Then, in the case of driving shown in FIG. 11, positive electric charges are accumulated in the discharge electrode 5 in which discharging occurred and hence electric potential superimposed on the electric potential of the bus electrode becomes electric potential of the electrode 5.

During a sustain period, sustain pulses with positive and negative polarities are alternately applied to only the bus electrode 3. On the other hand, different electric potential is applied to the discharge electrodes 4 and 9. In the example shown in FIG. 11, positive electric potential (Vs—High) is applied to the discharge electrode 4 and negative electric potential (Vs—Low) is applied to the discharge electrode 9.

With application of different electric potential to the discharge electrodes 4 and 9 as described above, it is possible to lower the voltage of the sustain pulse applied to the bus electrode 3 by an amount of an electric potential difference.

Also, when the sustain pulse and the electric potential are applied to the electrodes as described above, as shown by arrows in FIG. 10, the sustain discharging 1 is generated from the DC type discharge electrode 4 of the high electric potential side to the floating discharge electrode 5 and next, sustain discharging 2 is generated from the floating discharge electrode 5 to the DC type discharge electrode 9 of the low electric potential side. In this manner, discharging can change over at every polarity of sustain discharging.

Also, with respect to the alternating current pulses applied to the bus electrode 3 and the discharge electrode 4, it is needless to say that the same AC operation can be carried out by alternately applying the pulses with the same polarity to the two electrodes as shown in FIG. 4 or by applying the pulses with the positive and negative polarities only to the bus electrode 3, for example.

1. In an AC type plasma display panel including a plurality of a pair of discharge electrodes and which can be operated by alternately applying pulses of different polarities to the two discharge electrodes, a plasma display panel characterized in that one side of said pair of discharge electrodes is formed as a floating discharge electrode in which a bus electrode to which a discharging current is supplied is covered with a dielectric layer, a conducting electrode material with excellent discharge electrode characteristics being formed as floating discharge electrodes separated at every pixel across said bus electrode and said dielectric layer, the other side of said pair of discharge electrodes has a structure in which the bus electrode is not covered with the dielectric layer but it is formed as a stripe-like discharge electrode exposed to the discharge space or an electrode formed on the bus electrode and of which surface is coated with said similar conducting electrode material but is not covered with the dielectric layer and that these electrodes are constructed as a pair of discharge electrodes.

2. In a plasma display panel according to claim 1, plasma display panel characterized in that, said discharge electrode covered with said dielectric layer in said pair of discharge electrodes has the floating discharge electrode, which is formed through said dielectric layer, been divided at both sides of a line width direction of said bus electrodes, that is, a line width of the direction perpendicular to said bus electrode to provide two independent discharge electrodes relative to said bus electrode.

3. In a plasma display panel according to claim 1, a plasma display panel characterized in that said floating discharge electrode and said stripe-like discharge electrodes, which are not covered with said dielectric layer, are extended in parallel to said bus electrode so as to sandwich said floating discharge electrode to construct a four-electrode arrangement together with an address electrode.

4. In a method of driving a plasma display panel having a four-electrode arrangement claimed in claim 3, a method of driving a plasma display panel characterized in that said plasma display panel is driven in such a manner that one stripe-like discharge electrode of said two stripe-like discharge electrodes sandwiching said floating electrodes is held at constant positive electric potential, the other stripe-like discharge electrode being held at constant negative electric potential during a sustain period.
